(19) United States
(12) Patent Application Publication
(10) Pub. No.: US 2025/0236498 A1
(43) Pub. Date: Jul. 24, 2025

(54) SAFETY FIELD SWITCHING BASED ON END EFFECTOR CONDITIONS IN VEHICLES

(71) Applicant: Seegrid Corporation, Pittsburgh, PA (US)

(72) Inventors: Nathan Greco, Beaver, PA (US); Bruce Thompson, Pittsburgh, PA (US); David Deutsch, Evans City, PA (US); Miguel Rodriguez, Pittburgh, PA (US); Adam Grusky, Pittsburgh, PA (US); Brian Dunlavey, Pittsburgh, PA (US)

(21) Appl. No.: 18/838,795

(22) PCT Filed: Mar. 28, 2023
(86) PCT No.: PCT/US2023/016565

§ 371 Date: Aug. 15, 2024

Related U.S. Application Data
(60) Provisional application No. 63/324,184, filed on Mar. 28, 2022.

(51) Int. Cl. B66F 9/06; B66F 9/075; B66F 9/24

(52) U.S. Cl. CPC B66F 9/063; B66F 9/0755; B66F 9/24

(57) ABSTRACT

An autonomous mobile robot may include a processor configured to employ exteroceptive and proprioceptive information. The processor may employ exteroceptive information to guide the robot. The processor may employ proprioceptive information to guide the robot's manipulation of an object within its environment.

### CROSS REFERENCE TO RELATED APPLICATIONS

The present application claims priority to U.S. Provisional Appl. 63/324,184 filed on Mar. 28, 2022, entitled Safety Field Switching Based On End Effector Conditions in Vehicles which is incorporated herein by reference in its entirety.

The present application may be related to U.S. Provisional Appl. 63/430,184 filed on Dec. 5, 2022, entitled Just in Time Destination Definition and Route Planning; U.S. Provisional Appl. 63/430,190 filed on Dec. 5, 2022, entitled Configuring a System that Handles Uncertainty with Human and Logic Collaboration in a Material Flow Automation Solution; U.S. Provisional Appl. 63/430,182 filed on Dec. 5, 2022, entitled Composable Patterns of Material Flow Logic for the Automation of Movement; U.S. Provisional Appl. 63/430,174 filed on Dec. 5, 2022, entitled Process Centric User Configurable Step Framework for Composing Material Flow Automation: U.S. Provisional Appl. 63/430,195 filed on Dec. 5, 2022, entitled Generation of “Plain Language” Descriptions Summary of Automation Logic; U.S. Provisional Appl. 63/430,171 filed on Dec. 5, 2022, entitled Hybrid Autonomous System Enabling and Tracking Human Integration into Automated Material Flow; U.S. Provisional Appl. 63/430,180 filed on Dec. 5, 2022, entitled A System for Process Flow Templating and Duplication of Tasks Within Material Flow Automation; U.S. Provisional Appl. 63/430,200 filed on Dec. 5, 2022, entitled A Method for Abstracting Integrations Between Industrial Controls and Autonomous Mobile Robots (AMRs); and U.S. Provisional Appl. 63/430,170 filed on Dec. 5, 2022, entitled Visualization of Physical Space Robot Queuing Areas as Non Work Locations for Robotic Operations, each of which is incorporated herein by reference in its entirety.

The present application may be related to U.S. Provisional Appl. 63/348,520 filed on Jun. 3, 2022, entitled System and Method for Generating Complex Runtime Path Networks from Incomplete Demonstration of Trained Activities; U.S. Provisional Appl. 63/410,355 filed on Sep. 27, 2022, entitled Dynamic. Deadlock-Free Hierarchical Spatial Mutexes Based on a Graph Network, U.S. Provisional Appl. 63/346,483 filed on May 27, 2022, entitled System and Method for Performing Interactions with Physical Objects Based on Fusion of Multiple Sensors; and U.S. Provisional Appl. 63/348,542 filed on Jun. 3, 2022, entitled Lane Grid Setup for Autonomous Mobile Robots (AMRs); U.S. Provisional Appl. 63/423,679, filed Nov. 8, 2022, entitled System and Method for Definition of a Zone of Dynamic Behavior with a Continuum of Possible Actions and Structural Locations within Same; U.S. Provisional Appl. 63/423,683, filed Nov. 8, 2022, entitled System and Method for Optimized Traffic Flow Through Intersections with Conditional Convoying Based on Path Network Analysis; U.S. Provisional Appl. 63/423,538, filed Nov. 8, 2022, entitled Method for Calibrating Planar Light-Curtain; each of which is incorporated herein by reference in its entirety.

The present application may be related to U.S. Provisional Appl. 63/324,182 filed on Mar. 28, 2022, entitled A Hybrid. Context-Aware Localization System For Ground Vehicles; U.S. Provisional Appl. 63/324,185 filed on Mar. 28, 2022, entitled Dense Data Registration From a Vehicle Mounted Sensor Via Existing Actuator; U.S. Provisional Appl. 63/324,187 filed on Mar. 28, 2022, entitled Extrinsic Calibration Of A Vehicle-Mounted Sensor Using Natural Vehicle Features; U.S. Provisional Appl. 63/324,188 filed on Mar. 28, 2022, entitled Continuous And Discrete Estimation Of Payload Engagement/Disengagement Sensing; U.S. Provisional Appl. 63/324,190 filed on Mar. 28, 2022, entitled Passively Actuated Sensor Deployment; U.S. Provisional Appl. 63/324,192 filed on Mar. 28, 2022, entitled Automated Identification Of Potential Obstructions In A Targeted Drop Zone; U.S. Provisional Appl. 63/324,193 filed Mar. 28, 2022, entitled Localization of Horizontal Infrastructure Using Point Clouds, U.S. Provisional Appl. 63/324,195 filed on Mar. 28, 2022, entitled Navigation Through Fusion of Multiple Localization Mechanisms and Fluid Transition Between Multiple Navigation Methods; U.S. Provisional Appl. 63/324,198 filed on Mar. 28, 2022, entitled Segmentation Of Detected Objects Into Obstructions And Allowed Objects; U.S. Provisional Appl. 62/324,199 filed on Mar. 28, 2022, entitled Validating The Pose Of An AMR That Allows It To Interact With An Object; and U.S. Provisional Appl. 63/324,201 filed on Mar. 28, 2022, entitled A System For AMRs That Leverages Priors When Localizing Industrial Infrastructure; each of which is incorporated herein by reference in its entirety.

The present application may be related to U.S. patent application Ser. No. 11/350,195, filed on Feb. 8, 2006, U.S. Pat. No. 7,446,766, Issued on Nov. 4, 2008, entitled Multidimensional Evidence Grids and System and Methods for Applying Same; U.S. patent application Ser. No. 12/263,983 filed on Nov. 3, 2008, U.S. Pat. No. 8,427,472, Issued on Apr. 23, 2013, entitled Multidimensional Evidence Grids and System and Methods for Applying Same; U.S. patent application Ser. No. 11/760,859, filed on Jun. 11, 2007, U.S. Pat. No. 7,880,637, Issued on Feb. 1, 2011, entitled Low-Profile Signal Device and Method For Providing Color-Coded Signals; U.S. patent application Ser. No. 12/361,300 filed on Jan. 28, 2009, U.S. Pat. No. 8,892,256, Issued on Nov. 18, 2014, entitled Methods For Real-Time and Near-Real Time Interactions With Robots That Service A Facility; U.S. patent application Ser. No. 12/361,441, filed on Jan. 28, 2009, U.S. Pat. No. 8,838,268, Issued on Sep. 16, 2014, entitled Service Robot And Method Of Operating Same; U.S. patent application Ser. No. 14/487,860, filed on Sep. 16, 2014, U.S. Pat. No. 9,603,499, Issued on Mar. 28, 2017, entitled Service Robot And Method Of Operating Same; U.S. patent application Ser. No. 12/361,379, filed on Jan. 28, 2009, U.S. Pat. No. 8,433,442, Issued on Apr. 30, 2013, entitled Methods For Repurposing Temporal-Spatial Information Collected By Service Robots; U.S. patent application Ser. No. 12/371,281, filed on Feb. 13, 2009, U.S. Pat. No. 8,755,936, Issued on Jun. 17, 2014, entitled Distributed Multi-Robot System; U.S. patent application Ser. No. 12/542,279, filed on Aug. 17, 2009, U.S. Pat. No. 8,169,596, Issued on May 1, 2012, entitled System And Method Using A Multi-Plane Curtain; U.S. patent application Ser. No. 13/460,096, filed on Apr. 30, 2012, U.S. Pat. No. 9,310,608, Issued on Apr. 12, 2016, entitled System And Method Using A Multi-Plane Curtain; U.S. patent application Ser. No. 15/096,748, filed on Apr. 12, 2016, U.S. Pat. No. 9,910,137, Issued on Mar. 6, 2018, entitled System and Method Using A Multi-Plane Curtain; U.S. patent application Ser. No. 13/530,876, filed on Jun. 22, 2012, U.S. Pat. No. 8,892,241, Issued on Nov. 18, 2014, entitled Robot-Enabled Case Picking; U.S. patent application Ser. No. 14/543,241, filed on Nov. 17, 2014, U.S. Pat. No. 9,592,961, Issued on Mar. 14, 2017, entitled Robot-Enabled Case Picking; U.S. patent application Ser. No. 13/168,639, filed on Jun. 24, 2011, U.S. Pat. No. 8,864,164, Issued on Oct. 21, 2014, entitled Tugger Attachment; U.S. Design patent application 29/398,127, filed on Jul. 26, 2011, U.S. Pat. No. D680,142, Issued on Apr. 16, 2013, entitled Multi-Camera Head; U.S. Design patent application 29/471,328, filed on Oct. 30, 2013, U.S. Pat. No. D730,847, Issued on Jun. 2, 2015, entitled Vehicle Interface Module; U.S. patent application Ser. No. 14/196,147, filed on Mar. 4, 2014, U.S. Pat. No. 9,965,856, Issued on May 8, 2018, entitled Ranging Cameras Using A Common Substrate; U.S. patent application Ser. No. 16/103,389, filed on Aug. 14, 2018, U.S. Pat. No. 11,292,498, Issued on Apr. 5, 2022, entitled Laterally Operating Payload Handling Device; U.S. patent application Ser. No. 16/892,549, filed on Jun. 4, 2020, US Publication Number 2020/0387154, Published on Dec. 10, 2020, entitled Dynamic Allocation And Coordination of Auto-Navigating Vehicles and Selectors; U.S. patent application Ser. No. 17/163,973, filed on Feb. 1, 2021, US Publication Number 2021/0237596, Published on Aug. 5, 2021, entitled Vehicle Auto-Charging System and Method; U.S. patent application Ser. No. 17/197,516, filed on Mar. 10, 2021, US Publication Number 2021/0284198, Published on Sep. 16, 2021, entitled Self-Driving Vehicle Path Adaptation System and Method; U.S. patent application Ser. No. 17/490,345, filed on Sep. 30, 2021, US Publication Number 2022-0100195, published on Mar. 31, 2022, entitled Vehicle Object-Engagement Scanning System And Method; U.S. patent application Ser. No. 17/478,338, filed on Sep. 17, 2021, US Publication Number 2022-0088980, published on Mar. 24, 2022, entitled Mechanically-Adaptable Hitch Guide each of which is incorporated herein by reference in its entirety.

### FIELD OF INTEREST

Inventive concepts relate to systems and methods in the field of robotic vehicles such as autonomous mobile robots (AMR). Aspects of the inventive concepts are applicable to any mobile robotics application, particularly those involving manipulation. More specifically, the present inventive concepts relate to systems and methods involving safety in autonomous and/or robotic vehicles.

### BACKGROUND

An autonomous mobile robot (AMR) may be protected by safety fields to prevent hitting obstacles within its environment. An AMR that includes a manipulation assembly, such as forks and lifting apparatus complicates the process of providing safety while at the same time allowing for interaction with or manipulation of the AMR's environment.

### SUMMARY OF THE INVENTION

In accordance with one aspect of the inventive concepts, provided is an autonomous mobile robot, comprising: a processor; an exteroceptive sensing element to obtain exteroceptive information about the robot's environment; a manipulation mechanism to manipulate an object within the robot's environment; and a proprioceptive sensing element to obtain proprioceptive information about the robot, wherein the processor is configured to employ the exteroceptive information to guide the robot and proprioceptive information to manipulate an object within the robot's environment.

In various embodiments, the manipulation mechanism comprises a fork-lift mechanism.

In various embodiments, the processor is configured to establish a safety field to guide the robot.

In various embodiments, the proprioceptive information includes information about the status of the fork-lift mechanism.

In various embodiments, the proprioceptive information includes information about the status of a robot's manipulation operation.

In accordance with one aspect of the inventive concepts, provided is an autonomous mobile robot, comprising: at least one processor in communication with at least one computer memory device; a safety field system configured to generate a safety field; at least one sensor configured to acquire sensor data based on a state of the robot; and a safety field adjusting system configured to adjust the safety field based on the sensor data.

In various embodiments, the safety field adjusting system is configured to adjust an area, depth, footprint, and/or direction of the safety field.

In various embodiments, the safety field adjusting system is configured to adjust the safety field in a travel direction of the robot.

In various embodiments, the safety field adjusting system is configured to adjust the safety field relative to a payload of the robot.

In various embodiments, the state of the robot comprises and/or indicates at least one of a lift, a tilt, a reach, and a side-shift of the robot or a portion of the robot.

In various embodiments, the robot further comprises at least one sensor configured to acquire payload engagement sensor data based on a state of payload engagement.

In various embodiments, the safety field adjusting system is configured to adjust the safety field based on the payload engagement sensor data.

In various embodiments, the robot further comprises computer program code executable by the at least one processor to provide a signal configured to indicate load interaction.

In various embodiments, the safety field adjusting system is configured to adjust the safety field based on the load interaction signal.

In accordance with another aspect of the inventive concepts, provided is a method of dynamically adjusting and/or augmenting safety field of an autonomous mobile robot, comprising: establishing a safety field relative to the robot; at least one sensor acquiring sensor data based on a state of the robot; and a safety field adjusting system adjusting the safety field based on the sensor data.

In various embodiments, adjusting the safety field includes adjusting an area, depth, footprint, and/or direction of the safety field.

In various embodiments, adjusting the safety field includes adjusting the safety field in a travel direction of the robot.

In various embodiments, adjusting the safety field includes adjusting the safety field relative to a payload of the robot.

In various embodiments, the state of the robot comprises and/or indicates at least one of a lift, a tilt, a reach, and a side-shift of the robot or a portion of the robot.

In various embodiments, the method includes the at least one sensor acquiring payload engagement data based on a state of payload engagement.

In various embodiments, the method includes the safety field adjusting system adjusting the safety field based on the payload engagement sensor data.

In various embodiments, the method further comprising computer program code executable by the at least one processor providing a signal configured to indicate load interaction.

In various embodiments, the safety field adjusting system adjusts the safety field based on a signal from software, such as a load interaction signal.

In various embodiments, the safety field adjusting system adjusts the safety field based on a signal from software that indicates the AMR is interacting with a payload and the safety field will be reduced to allow approach to infrastructure.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals refer to the same or similar elements. In the drawings:

FIG. 1 is a perspective view of an AMR forklift that can be configured to implement dynamic path adjust, in accordance with aspects of the inventive concepts; and

FIG. 2 is a block diagram of an embodiment of an AMR, in accordance with aspects of the inventive concepts;

FIG. 3 through FIG. 5 illustrate various exteroceptive sensors that may be employed by an AMR in accordance with aspects of inventive concepts;

FIG. 6 and FIG. 7 illustrate various lift components such as may be employed by an AMR in accordance with aspects of inventive concepts;

FIG. 8 illustrates safety field sensor coverages such as may be employed by and AMR in accordance with aspects of inventive concepts;

FIGS. 9A through 16B illustrate the modification of safety fields during a manipulation operation performed by an AMR in accordance with aspects of inventive concepts; and

FIG. 17 illustrates operation of a payload presence sensor by an AMR in accordance with aspects of inventive concepts.

### DESCRIPTION OF PREFERRED EMBODIMENT

It will be understood that, although the terms first, second, etc. may be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements may be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

In the context of the inventive concepts, and unless otherwise explicitly indicated, a “real-time” action is one that occurs while the AMR is in-service and performing normal operations. This is typically in immediate response to new sensor data or triggered by some other event. The output of an operation performed in real-time will take effect upon the system so as to minimize any latency.

In humans, proprioception refers to a person's perception of the position of the different parts of his or her body. Exteroception refers to the sensations caused by external stimuli. Analogously, robotic vehicles, such as autonomous mobile robots (AMRs), may employ proprioceptive and exteroceptive sensors to navigate and interact with their environment. Exteroceptive sensors measure the state of the AMR's environment, for example, the relative positions, relative speeds, and relative accelerations, of objects in the AMR's environment.

Much as human proprioception may refer to sensing the position of different parts of the human body, proprioceptive sensors measure the state of an AMR itself. For example, an AMR may employ proprioceptive sensing to determine its wheel positions, component position, speed, or fuel level. In example embodiments an AMR configured to interact with or manipulate its environment, may employ the status of the AMR's manipulation mechanism as proprioceptive information. In example embodiments an AMR may employ information about the status of the AMR's execution of a process as proprioceptive information. That is, in accordance with principles of inventive concepts an AMR may employ information, for example, about the progress of a manipulation process as proprioceptive information. In example embodiments where an AMR interacts with its environment through the use of manipulators such as forks, an AMR may employ sensors that detect the height, tilt, reach, and centering of the forks, for example, to control its operation. In particular, an AMR in accordance with principles of inventive concepts may employ proprioceptive sensing to control its operation in general and to control its response to exteroceptive sensing in particular.

Inventive concepts may be applied to any scenario in which an AMR manipulates an object within its environment. Such concepts may be used in an application where the AMR employs a forklift mechanism, in a warehousing environment for example, to pick or place a payload. Inventive concepts may be employed in agricultural or forestry applications, as well. For example, in agriculture, proprioceptive information may be employed in an agricultural or forestry application to determine whether an object is a weed (do be picked) or a crop item (to be watered or fertilized). Similarly, in forestry such information may be employed by an AMR in accordance with principles of inventive concepts to determine navigation and manipulation strategies for pruning and picking branches or fruits. Inventive concepts may be employed in AMRs used in retail settings, such as grocery store restockers and inventory counters. AMRs involved in maintenance and inspection may also employ inventive concepts in navigating and inspecting objects in the environment. Different forms of manipulators, including for example, forklift mechanisms, graspers, pincers, or others, may be employed in conjunction with an AMR in accordance with principles of inventive concepts. For brevity and clarity of explanation, inventive concepts will be described primarily in reference to an AMR operating within a warehouse environment and using a forklift mechanism to manipulate objects.

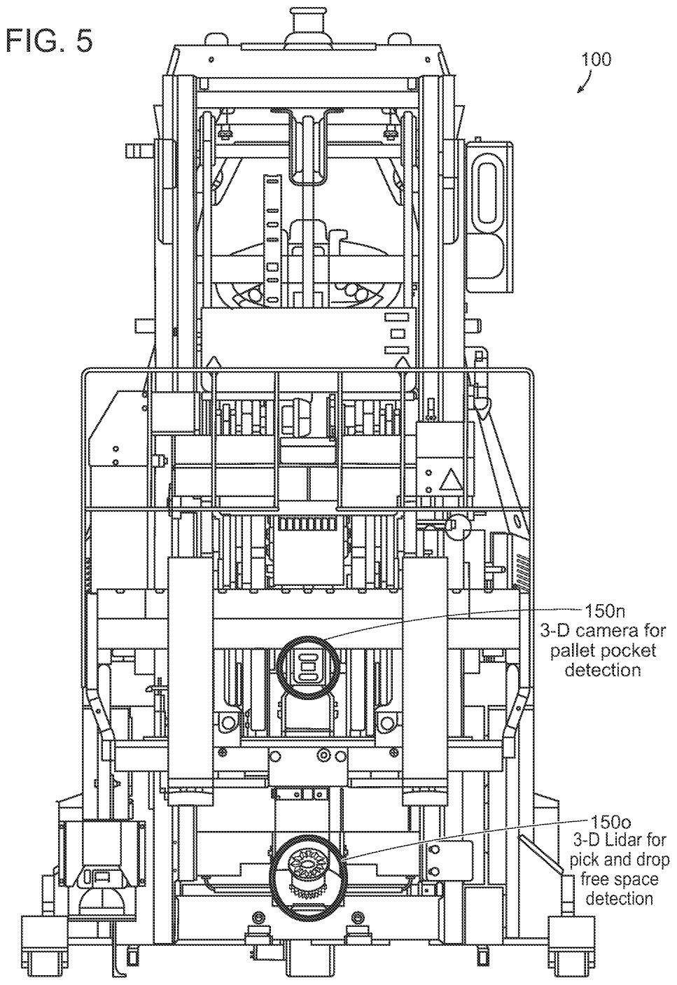

In example embodiments, a robotic vehicle such as an AMR may employ safety fields to ensure safe operation. The safety fields, a group of which may be referred to as a safety field set, provide a buffer zone of a sort to prevent collisions between the AMR and anything, whether moving or not, animate or not, within the AMR's environment. In example embodiments an AMR may employ exteroceptive sensors, which are responsive to external stimuli, to establish safety fields around the AMR and may employ proprioceptive sensors to adjust or control the extent, direction and shape of the safety fields. An AMR in accordance with principles of inventive concepts may control, or adjust, aspects of its safety fields, or safety sets, based at least in part upon proprioceptive information, such as that obtained from proprioceptive sensors. Such control or adjustment may include a modification to the extent or shape of a safety field, depending upon proprioceptive information, with safety fields set to meet or exceed safety regulations and standards during nominal operating conditions and adjusting the field sets for other operating conditions. In some example embodiments “nominal operating conditions” may refer, for example, to an AMR lift truck traveling forward (that is, in a direction generally away from the direction in which the forks point) with its forks in a travel configuration (forks at a travel height, forks centered, and forks retracted). The extent and shape of the safety fields may be adjusted by the AMR according to its speed (safety field expanded for higher speeds) and directionality (safety fields reduced or reshaped to accommodate turns). Safety fields may be adjusted according to whether the AMR is reversing (traveling generally in the direction in which the forks are pointing), the fork configuration (for example, fork height, fork tilt, fork reach, or fork centering) and whether the AMR is engaged in a manipulation operation (pick or place, for example). A system according to the present inventive concepts modifies the PLd safety field coverage based on the positional configurations of various axes of motion (lift, tilt, reach, sideshift, etc.). The system is directed to a mobile robotics platform, such as an AMR configured to carrying and/or towing a load, such as that shown in FIG. 5. Such AMRs can include, as examples, forklifts and tugger AMRs, wherein the forklift AMRs can include actuated fork tines configured to engage, lift, and carry at least one palletized load.

The system includes an arrangement of Performance Level—d (PLd) (per ISO-13849-1) safety sensors indicating various positions and arrangements of the fork tines, as well as a state of payload engagement. The system further includes one or more PLd (per ISO-13849-1) safety lidar sensors with field occlusion detection, which generate one or more safety fields. A combination of safety fields can be referred to as a safety field set. The system further includes a PLd (per ISO-13849-1) safety controller. Detection of an object in a safety field can cause the safety controller to halt or otherwise modify the navigation of the AMR for object avoidance, through interaction with a navigation controller, drive system, and/or brake system.

A method of implementing the system includes, during operation, the safety controller is constructed and arranged to modify the safety field geometry, e.g., area, footprint, direction, etc.) and speed limits based upon the combinatorial state of various sensors. Identifying the location of mast components via PLd safety rated sensors in a non-nominal location (identified as a load interaction state) limits the speed of the AMR to below what is defined in B56.5 as safe without safety field coverage. A software signal will indicate load interaction, which limits the speed of the AMR as well as reduces coverage at the rear (load area) of the AMR (from the forks or any area of the AMR that engages the payload) allowing the AMR to approach a table, racking, or other infrastructure to engage (e.g., pick) or place a load. Limiting speed results in the AMR being compliant with B56.5. Verification of the mast components using PLd safety rated sensors in a nominal state allows for the fields to be reduced in size to improve maneuverability of the AMR

In addition to speed and turn angle, according to the present inventive concepts, AMR forklift truck safety fields may change based on location of various truck components. For example, the safety fields may be changed based on at least one of side-shift, reach, lift height, tilt and payload presence. According to the present inventive concepts, proprioceptive sensors which obtain information based on the state of the robot itself are used to change how the truck interacts with exteroceptive effects. That is, safety fields may be changed to adapt to how the AMR forklift can maneuver within its environment. The inputs for the sensors are Performance Level—d (PLd) safety rated. Use of these inputs allows the AMR forklift to have better maneuverability by being able to reduce safety fields based on the position of the mast components. For an AMR forklift to approach infrastructure, such as a table or rack for pick and place, a signal is generated that indicates the “intention” of the truck to need to approach the infrastructure without obstruction. In example embodiments the “intention” may be determined by the AMR's commencement of a manipulation operation, such as a pick or place, as determined by the AMR's training or programming, for example. This signal in addition to non-nominal location of mast components may also prevent the AMR from exceeding speeds that would be considered unsafe without proper protection as specified in B56.5.

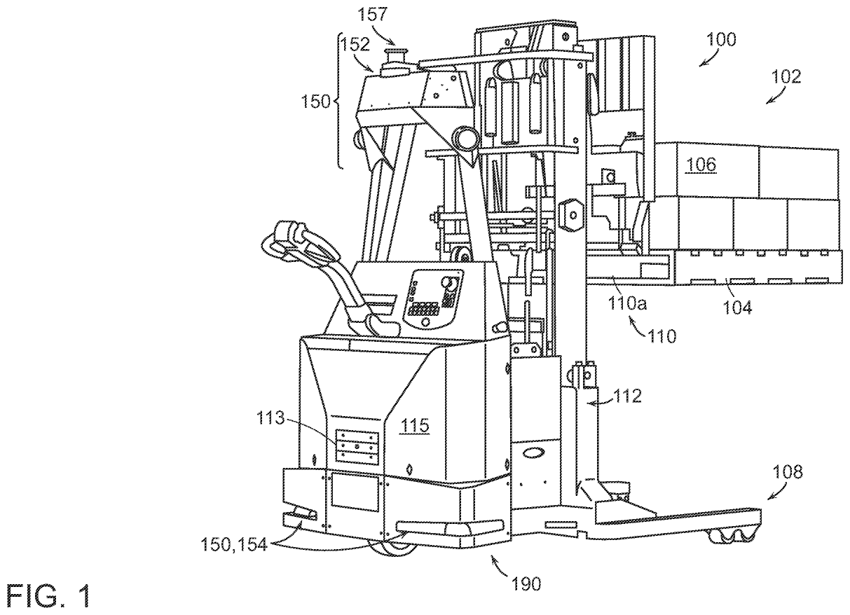

Referring to FIG. 1, shown is an example of a robotic vehicle 100 in the form of an AMR that can be configured with the sensing, processing, and memory devices and subsystems necessary and/or useful for performing dynamic path adjust in accordance with aspects of the inventive concepts. The robotic vehicle 100 takes the form of an AMR pallet lift, but the inventive concepts could be embodied in any of a variety of other types of robotic vehicles and AMRs, including, but not limited to, pallet trucks, tuggers, and the like.

In this embodiment, the robotic vehicle 100 includes a payload area 102 configured to transport a pallet 104 loaded with goods 106. To engage and carry the pallet 104, the robotic vehicle may include a pair of forks 110, including a first and second forks 10a,b. Outriggers 108 extend from the robotic vehicle in the direction of the forks to stabilize the vehicle, particularly when carrying the palletized load 106. The robotic vehicle 100 can comprise a battery area 112 for holding one or more batteries. In various embodiments, the one or more batteries can be configured for charging via a charging interface 113. The robotic vehicle 100 can also include a main housing 115 within which various control elements and subsystems can be disposed, including those that enable the robotic vehicle to navigate from place to place.

The robotic vehicle 100 may include a plurality of sensors 150 that provide various forms of sensor data that enable the robotic vehicle to safely navigate throughout an environment, engage with objects to be transported, and avoid obstructions. In various embodiments, the sensor data from one or more of the sensors 150 can be used for path adaptation, including avoidance of detected objects, obstructions, hazards, humans, other robotic vehicles, and/or congestion during navigation. The sensors 150 can include one or more cameras, stereo cameras 152, radars, and/or laser imaging, detection, and ranging (LiDAR) scanners 154. One or more of the sensors 150 can form part of a 2D or 3D high-resolution imaging system. The sensors 150 can also include a LiDAR 157, such as a 2D or 3D LiDAR sued for localization and/or navigation.

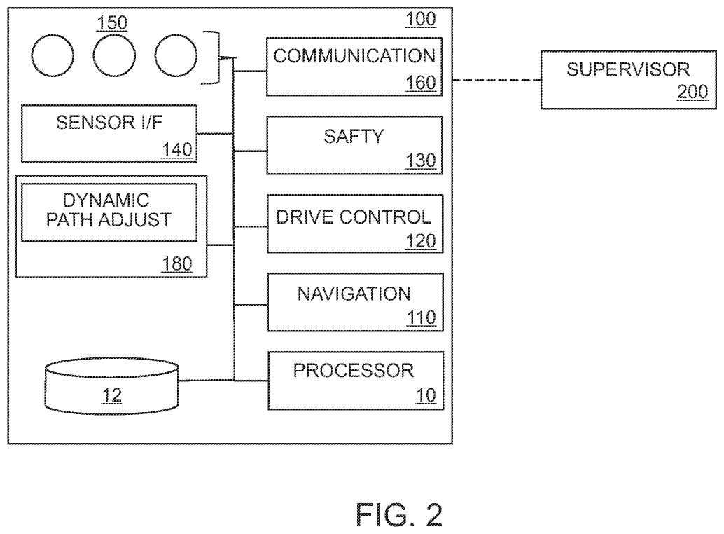

FIG. 2 is a block diagram of components of an embodiment of the robotic vehicle 100 of FIG. 1, incorporating path adaptation technology in accordance with principles of inventive concepts. The embodiment of FIG. 2 is an example; other embodiments of the robotic vehicle 100 can include other components and/or terminology. In the example embodiment shown in FIGS. 1 and 2, the robotic vehicle 100 is a warehouse robotic vehicle, which can interface and exchange information with one or more external systems, including a supervisor system, fleet management system, and/or warehouse management system (collectively “Supervisor 200”). In various embodiments, the supervisor 200 could be configured to perform, for example, fleet management and monitoring for a plurality of vehicles (e.g., AMRs) and, optionally, other assets within the environment. The supervisor 200 can be local or remote to the environment, or some combination thereof.

In various embodiments, the supervisor 200 can be configured to provide instructions and data to the robotic vehicle 100, and to monitor the navigation and activity of the robotic vehicle and, optionally, other robotic vehicles. The robotic vehicle can include a communication module 160 configured to enable communications with the supervisor 200 and/or any other external systems. The communication module 160 can include hardware, software, firmware, receivers and transmitters that enable communication with the supervisor 200 and any other external systems over any now known or hereafter developed communication technology, such as various types of wireless technology including, but not limited to, WiFi, Bluetooth, cellular, global positioning system (GPS), radio frequency (RF), and so on.

As an example, the supervisor 200 could wirelessly communicate a path for the robotic vehicle 100 to navigate for the vehicle to perform a task or series of tasks. The path can be relative to a map of the environment stored in memory and, optionally, updated from time-to-time, e.g., in real-time, from vehicle sensor data collected in real-time as the robotic vehicle 100 navigates and/or preforms its tasks. The sensor data can include sensor data from sensors 150. As an example, in a warehouse setting the path could include a plurality of stops along a route for the picking and loading and/or the unloading of goods. The path can include a plurality of path segments. The navigation from one stop to another can comprise one or more path segments. The supervisor 200 can also monitor the robotic vehicle 100, such as to determine robotic vehicle's location within an environment, battery status and/or fuel level, and/or other operating, vehicle, performance, and/or load parameters.

In example embodiments, a path may be developed by “training” the robotic vehicle 100. That is, an operator may guide the robotic vehicle 100 through a path within the environment while the robotic vehicle, through a machine-learning process, learns and stores the path for use in task performance and builds and/or updates an electronic map of the environment as it navigates. The path may be stored for future use and may be updated, for example, to include more, less, or different locations, or to otherwise revise the path and/or path segments, as examples.

As is shown in FIG. 2, in example embodiments, the robotic vehicle 100 includes various functional elements, e.g., components and/or modules, which can be housed within the housing 115. Such functional elements can include at least one processor 10 coupled to at least one memory 12 to cooperatively operate the vehicle and execute its functions or tasks. The memory 12 can include computer program instructions, e.g., in the form of a computer program product, executable by the processor 10. The memory 12 can also store various types of data and information. Such data and information can include route data, path data, path segment data, pick data, location data, environmental data, and/or sensor data, as examples, as well as the electronic map of the environment.

In this embodiment, the processor 10 and memory 12 are shown onboard the robotic vehicle 100 of FIG. 1, but external (offboard) processors, memory, and/or computer program code could additionally or alternatively be provided. That is, in various embodiments, the processing and computer storage capabilities can be onboard, offboard, or some combination thereof. For example, some processor and/or memory functions could be distributed across the supervisor 200, other vehicles, and/or other systems external to the robotic vehicle 100.

The functional elements of the robotic vehicle 100 can further include a navigation module 110 configured to access environmental data, such as the electronic map, and path information stored in memory 12, as examples. The navigation module 110 can communicate instructions to a drive control subsystem 120 to cause the robotic vehicle 100 to navigate its path within the environment. During vehicle travel, the navigation module 110 may receive information from one or more sensors 150, via a sensor interface (I/F) 140, to control and adjust the navigation of the robotic vehicle. For example, the sensors 150 may provide sensor data to the navigation module 110 and/or the drive control subsystem 120 in response to sensed objects and/or conditions in the environment to control and/or alter the robotic vehicle's navigation. As examples, the sensors 150 can be configured to collect sensor data related to objects, obstructions, equipment, goods to be picked, hazards, completion of a task, and/or presence of humans and/or other robotic vehicles.

A safety module 130 can also make use of sensor data from one or more of the sensors 150, including LiDAR scanners 154, to interrupt and/or take over control of the drive control subsystem 120 in accordance with applicable safety standard and practices, such as those recommended or dictated by the United States Occupational Safety and Health Administration (OSHA) for certain safety ratings. For example, if safety sensors detect objects in the path as a safety hazard, such sensor data can be used to cause the drive control subsystem 120 to stop the vehicle to avoid the hazard.

The sensors 150 can include one or more stereo cameras 152 and/or other volumetric sensors, sonar sensors, and/or LiDAR scanners or sensors 154, as examples. Inventive concepts are not limited to particular types of sensors. In various embodiments, sensor data from one or more of the sensors 150, e.g., one or more stereo cameras 152 and/or LiDAR scanners 154, can be used to generate and/or update a 2-dimensional or 3-dimensional model or map of the environment, and sensor data from one or more of the sensors 150 can be used for the determining location of the robotic vehicle 100 within the environment relative to the electronic map of the environment.

Examples of stereo cameras arranged to provide 3-dimensional vision systems for a vehicle, which may operate at any of a variety of wavelengths, are described, for example, in U.S. Pat. No. 7,446,766, entitled Multidimensional Evidence Grids and System and Methods for Applying Same and U.S. Pat. No. 8,427,472, entitled Multi-Dimensional Evidence Grids, which are hereby incorporated by reference in their entirety. LiDAR systems arranged to provide light curtains, and their operation in vehicular applications, are described, for example, in U.S. Pat. No. 8,169,596, entitled System and Method Using a Multi-Plane Curtain, which is hereby incorporated by reference in its entirety.

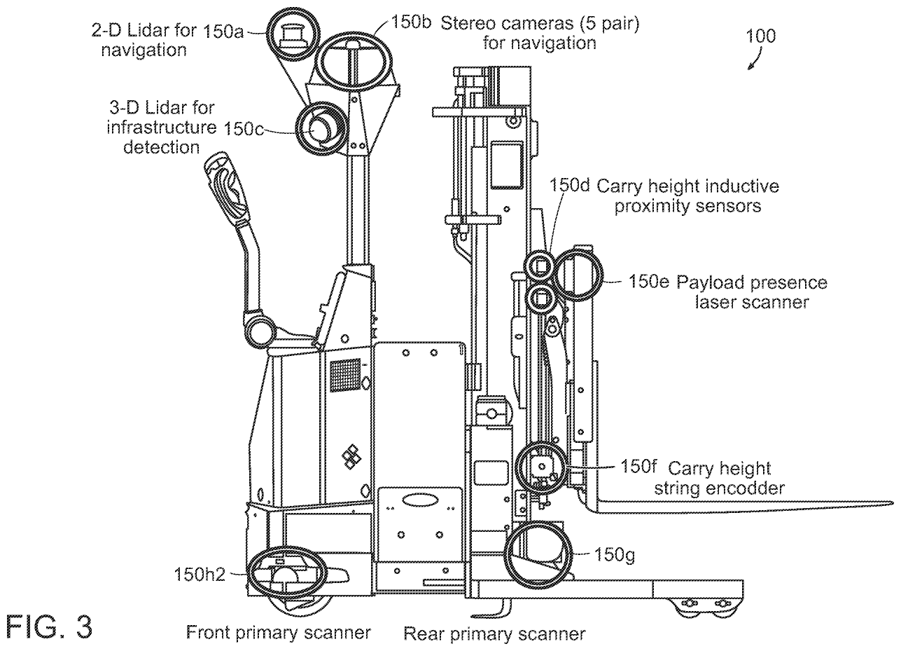

The robotic vehicle 100 (also referred to herein as AMR 100) of FIG. 3 provides a more detailed illustration of an example distribution of a sensor array such as may be employed by a lift truck embodiment of an AMR in accordance with principles of inventive concepts. In this example embodiment exteroceptive sensors include: a two-dimensional LiDAR 150a for navigation; stereo cameras 150b for navigation; three-dimensional LiDAR 150c for infrastructure detection; carry-height sensors 150d (inductive proximity sensors in example embodiments); payload/goods presence sensor 150e (laser scanner in example embodiments); carry height string encoder 150f; rear primary scanner 150g; and front primary scanner 150h.

Any sensor that can indicate presence/absence or measurement may be used to implement carry-height sensors 150d; in example embodiments they are attached to the mast and move with the lift, or inner mast. In example embodiments the sensors may be configured to indicate one of three positions: below carry height (both sensors on), at carry height (one on, one off), above carry height (both sensors off). Safety module 130 may employ those three states to control/change the primary safety fields. In example embodiments, when the forks are below carry height, the rear facing scanner may be ignored if the payload may be blocking the view of the scanner. When the forks are at carry height, and all other AMR factors are nominal (that is, reach is retracted, nominal speed, forks centered, etc.) standard safety fields may be for all scanners. When the lift is above carry height, the safety fields around the AMR may be expanded for added safety. The carry height string encoder 150f reports the height of the mast to safety module 130. Any of a variety of encoders or position sensing devices may be employed for this task in accordance with principles of inventive concepts. The carry height string encoder 150f may also be used in addition to or in place of the carry height inductive proximity sensors to adjust safety fields in accordance with principles of inventive concepts.

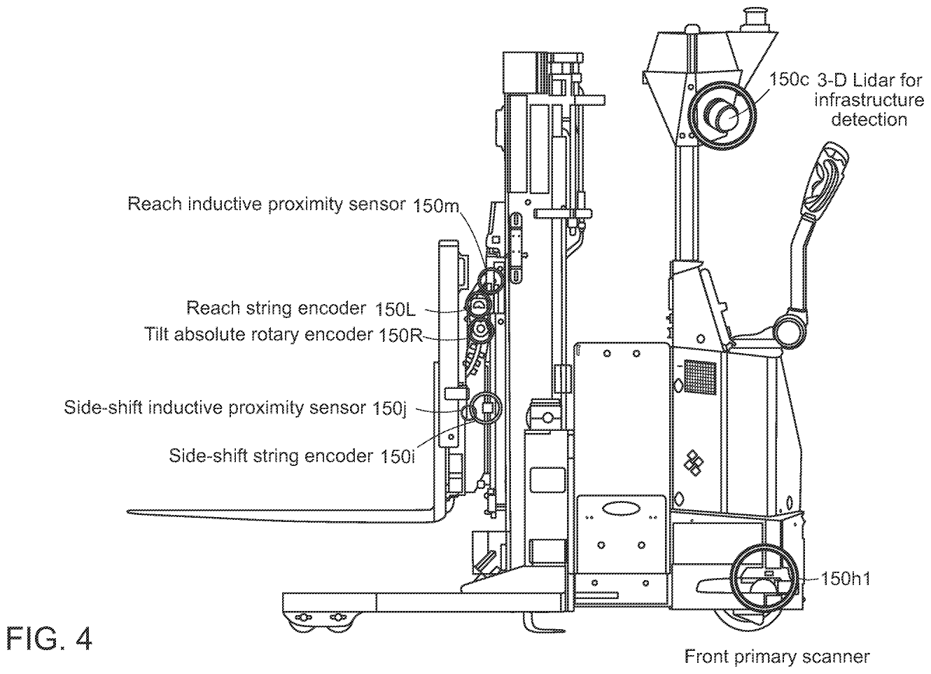

Additional scanners such may be employed by AMR 100 in accordance with principles of inventive concepts are shown in FIG. 4, where the sensors include: side shift string encoder 150i; side shift inductive proximity sensor 150j; tilt absolute rotary encoder 150k; reach string encoder 150l; and reach inductive proximity sensor 150m. Additionally, FIG. 5 illustrates an example embodiment of a robotic vehicle 100 that includes a three-dimensional camera 150n for pallet-pocket detection; and a three-dimensional LiDAR 150o for pick and drop free-space detection.

Any of a variety of sensors that may indicate presence/absence may be used to determine reach and, in example embodiments, an AMR employs an inductive proximity sensor 150m. In example embodiments, this sensor indicates whether or not the pantograph is fully retracted. In example embodiments a metal flag moves with the pantograph and when the metal flag trips the sensor, the reach is considered to be fully retracted. If the pantograph is not fully retracted, the safety fields may be expanded to provide greater safety coverage, for example, the same coverage as though the pantograph is fully extended. When the pantograph is fully retracted safety module 130 may minimize the safety fields to improve the maneuverability of the AMR 100. Reach string encoder 150l may be employed to indicate the position of the pantograph and may be used in place of or in conjunction with the reach proximity sensor 150m.

Although a variety of sensors that indicate presence or absences may be employed, in example embodiments side shift may be indicated by the side-shift inductive proximity sensor 150j. In example embodiments this sensor indicates whether the pantograph is centered left-to-right when viewing the AMR from the rear. In example embodiments a metal flag shifts with the pantograph and when this flag trips the senor, the pantograph is considered centered. If the pantograph is not centered and a payload is present, safety module 130 may expand safety fields to accommodate the payload for any position of the side-shift of the pantograph. In this manner an AMR in accordance with principles of inventive concepts may increase the maneuverability of the AMR by minimizing the safety fields when the pantograph is centered. The side-shift encoder 150i indicates the side-shift position of the pantograph and may be used in place of, or in conjunction with, the side-shift inductive proximity sensor 150j to adjust safety fields.

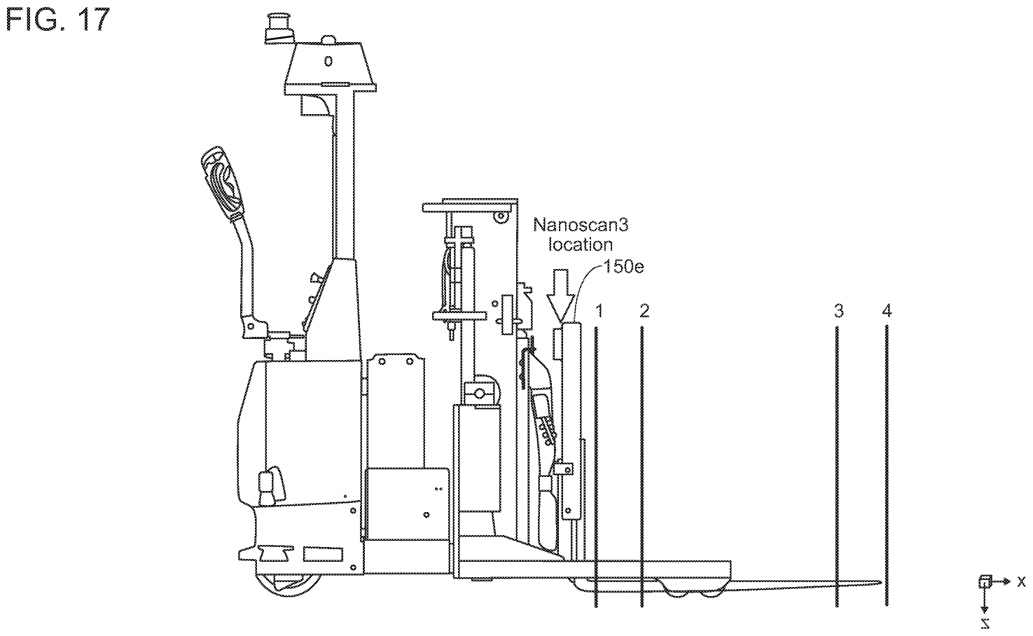

An example embodiment of a payload presence sensor 150e and its operation is shown in greater detail in FIG. 17. This example embodiment employs a laser scanner that establishes four fields described by vertical planes between the forks, labeled 1, 2, 3, and 4 in FIG. 17. In example embodiments, if anything is detected between the scanner 150e and field 4, the AMR payload is considered present. Safety module 130 may reduce safety fields to a minimum to improve AMR maneuverability in the absence of payload. In example embodiments scanner 150e may also be used to report the distance of an object from the scanner, as indicated by vertical plains 1,2,3 and 4.

In example embodiments an AMR may employ an inductive proximity sensor and encoder 150k to perform the tilt detection function of the pantograph. The tilt detection reports the pitch of the forks from front to back and may be employed by safety module 130 to adjust/control safety fields, for example. In example embodiments the sensors may provide binary results, such as presence or absence, which the safety module 130 may employ to establish a binary output, such as an expanded or compressed safety field. In example embodiments the sensors may provide graduated results, such as presence at a distance, which the safety module may employ to establish a graduated output, such as a variety of expansions or compressions of safety fields.

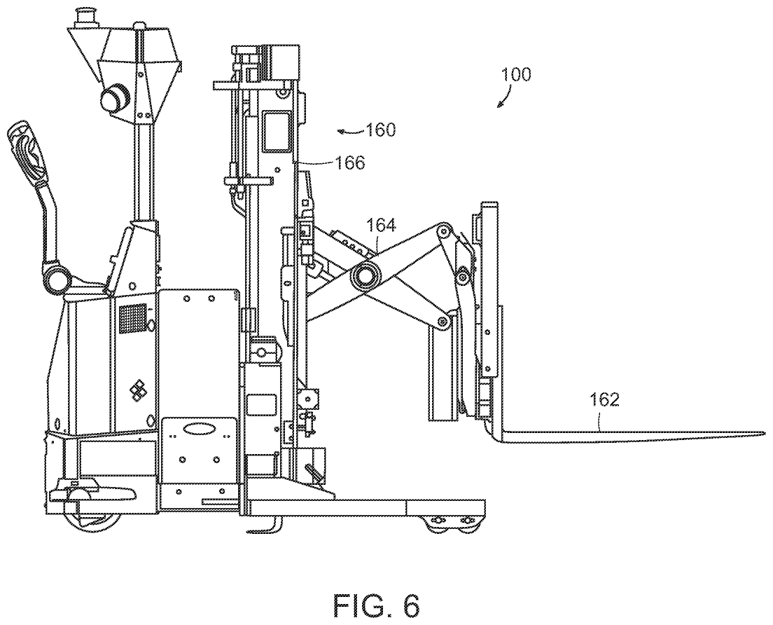

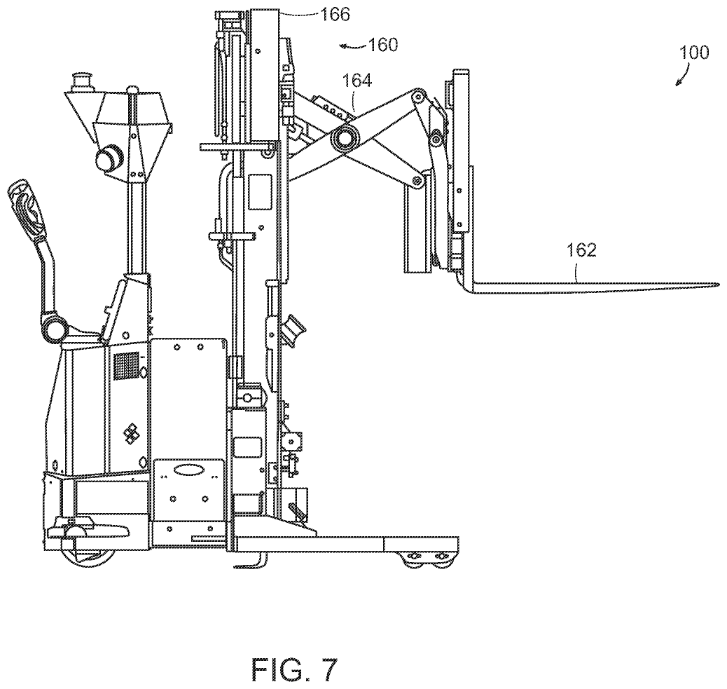

Turning now to FIG. 6, in example embodiments an AMR 100 may include components, which may be referred to herein collectively as mast 160, that includes forks 162, pantograph 164 and a vertical lifting assembly 166. Vertical lifting assembly 166 may include a lift cylinder, a tilt cylinder, a chain wheel, a chain, inner and outer masts, and a lift bracket, for example. Pantograph 164 may be extended or retracted to correspondingly extend or retract the “reach” of forks 162 away or toward the main body of the AMR. In the example of FIG. 6, lift assembly 166 has raised forks 162 to a travel height (a height suited for nominal vehicular travel within its given environment) and pantograph 164 has been extended to extend the reach of forks 162 away from the main body of robotic vehicle 100. A configuration such as this may be assumed by a vehicle 100 during the process of picking or placing a load, for example. FIG. 7 shows AMR 100 with forks 162 raised by lifting assembly 166 and extended by pantograph 164.

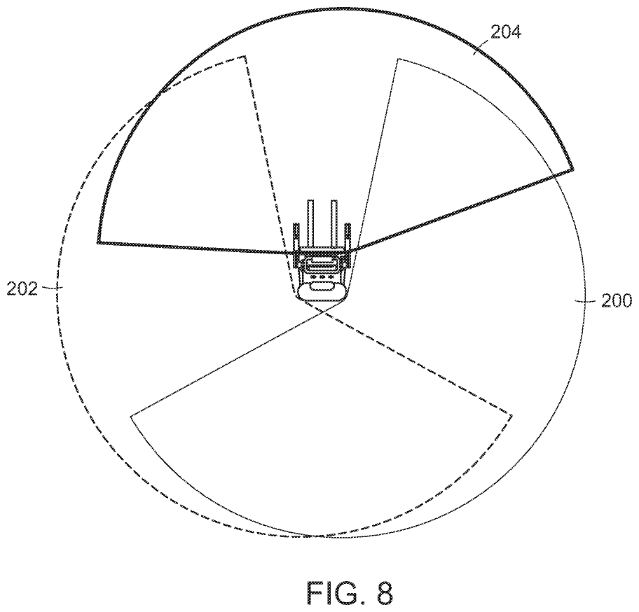

Scanning fields 200, 202, and 204 associated with primary scanners 150h2, 150hl, and 150g, respectively, are illustrated in the example embodiment of FIG. 8. In example embodiments primary scanners 150h2, 150h1, and 150g monitor planar areas seven inches above, and parallel to, the surface upon which the vehicle 100 travels. The size and shape of the fields 200, 202, and 204 in FIG. 8 are used for illustrative purposes and may, for example, extend beyond what is illustrated in FIG. 8. In example embodiments the fields illustrated in FIG. 8 may be referred to as scanning fields to denote their function as fields within which the AMR is responsive to exteroceptive sensing. Safety module 130 may set boundaries within these sensed zones to alert the vehicle 100 to potential hazards. Different boundaries may indicate different levels of risk and boundary sets may be established to provide warnings, for example, of anticipated risk or immediate risk. That is, a warning zone, a buffer zone of sorts, may be established relatively far from the vehicle 100 to alert the AMR to the potential that the relative motion of another object may indicate that the other object may enter a closer, safety, zone. The extent and shape of safety fields delineated by the AMR's controller (for example, safety module 130) may be determined by the vehicle 100's relative speed or whether it is turning or not, for example. For objects that appear within the warning zone, the vehicle 100 may adjust its speed. For objects that appear within the vehicle 100's safety zone, the vehicle 100 may come to stop and not move until the other object is outside the safety zone. A set of zones associated with a plurality of sensors may be referred to herein as a safety zone set or, simply, as a safety set. In accordance with principles of inventive concepts, the extent and shape of safety zones, or a safety set, may be controlled according to the AMR's proprioceptive sensing. That is, in accordance with principles of inventive concepts an AMR, such as an AMR configured to manipulate its environment (for example, a fork lift AMR picking or placing) may control its response to exteroceptive sensing, at least in part, by its proprioceptive sensing.

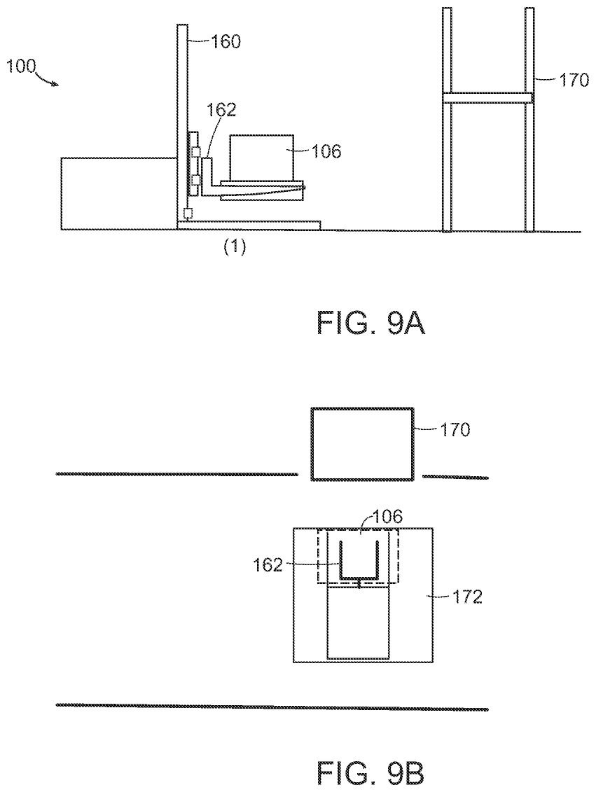

A sequence of vehicular movements corresponding to a payload “drop” operation will be used to illustrate example modifications to a safety zone set in accordance with principles of inventive concepts. FIGS. 9a, b through 16a, b will be used for this illustration. Robotic vehicle 100 is represented in these figures, somewhat abstractly, as a mast 160 and set of forks 162 carrying goods 106.

Turning to FIG. 9a, robotic vehicle 100 is positioned at a known distance from shelf 170, with the mast at carry-height, side-shift centered, reach fully retracted and is carrying goods 106. FIG. 9b illustrates a top view of robotic vehicle 100, with corresponding safety field 172. In example embodiments proprioceptive sensors that contribute to the determination of the size and shape of safety field 172 include: the direction (forward or reverse) of the vehicle, the speed of the vehicle, whether the vehicle is traveling in a straight line, the vertical position of the forks (for example, at carry height or at a raised height), the reach of the forks (for example, retracted or extended), whether the forks are centered are shifted to one side or another, and whether or not a payload (goods 106) is being hauled. In this example, the vehicle is going forward slowly in a straight line with the forks at a carry height with the reach retracted, side-shift centered, and a payload present. The corresponding safety field 172 for these conditions is illustrated in the top plan view of FIG. 9b. In example embodiments the designation of “forward” and “reverse” may encompass a situation where the vehicle 100 is not moving and the designation for a stationary vehicle may default to the value that obtained prior to the vehicle stopping. That is, for example, a vehicle 100 that was moving in reverse towards a shelf 170 then stops in the process of picking or placing goods 106 (also referred to herein as a payload) may retain the “reverse” directional designation, even while stationary, until it commences movement in the forward direction.

The safety field is a region that is set aside for safe operation of vehicle 100. If an object moved into the safety field through relative motion between the object and the vehicle (that is, through motion of the vehicle and/or the object), the vehicle 100 would come to a stop and not move until the object is removed from the safety field. As previously indicated, the extent and shape of the safety field may change according to one or more types of proprioceptive information, for example. In example embodiments, vehicle 100 may manipulate a payload by first approaching the payload 106 and supporting infrastructure (for example, shelf 170). In example embodiments, AMR 100 may modify its safety fields in order to allow it to approach the supporting infrastructure 170. The AMR 100 may employ proprioceptive information to make such modifications. In example embodiments AMR 100 reduces it's speed below a threshold level to comply with safety standards and regulations and employs proprioceptive sensors, for example, one or more of: direction; speed; acceleration; lift-height; reach status; side-shift status; or the presence of a payload, to adjust its safety zone to thereby allow the AMR 100 to safely carry out a manipulation operation such as a pick or place operation. In example embodiments the AMR 100 may employ its information regarding where it is in its intended route, it's location, and or it's manipulation status to anticipate when to adjust the safety field. For example, AMR 100 may have been trained or programmed to carry out a manipulation at a certain location and, as the AMR 100 approaches the target location it may employ its proprioceptive sensor information to adjust the safety field to thereby allow the vehicle to carry out its assigned manipulation. In example embodiments modification of the safety field maybe a binary process whereby the safety field is adjusted a set amount according to a threshold value or it may be a graduated process whereby the safety field is adjusted more or less according to the degree of change in height, centering, speed, tilt, reach or other proprioceptive sensor value.

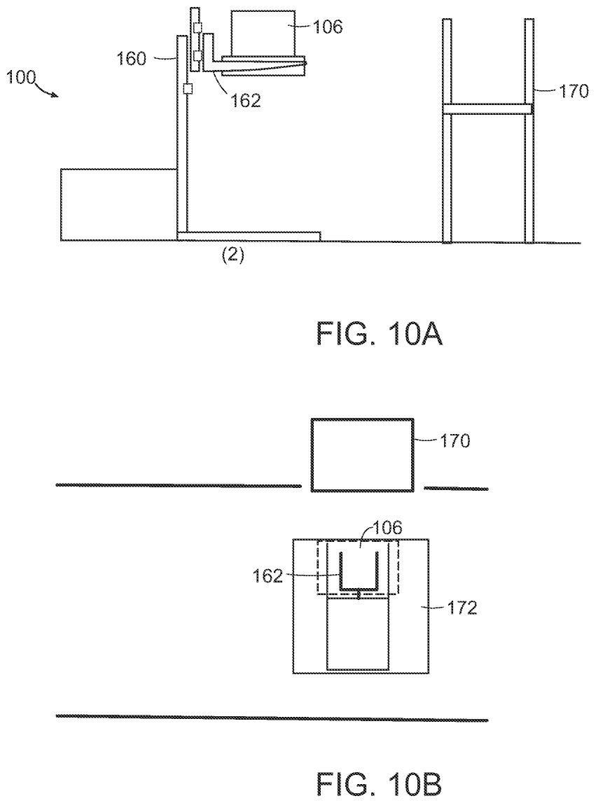

In the example embodiment of FIG. 10A the AMR 100 remains a known distance from shelf 170, is traveling “forward” (“forward” may be defined as a default value that encompasses both forward motion, that is, motion away from the direction of the forks), the AMR's speed is below a threshold level, in a straight direction, lift height is above travel level, reach is retracted, side shift is centered, and the payload is present. FIG. 10B illustrates that the safety field 172 has been extended laterally (compare to FIG. 9B) to accommodate the change in height of the forks. Using its proprioceptive sensors, AMR 100 has increased the extent of the safety field in this example embodiment by widening the field to provide extra protection for both the vehicle 100 and it's environment. Should an object appear within this expanded safety field, AMR 100 would stop operation (stop operation of the lift process) until the intruding object moves out of the expanded safety field.

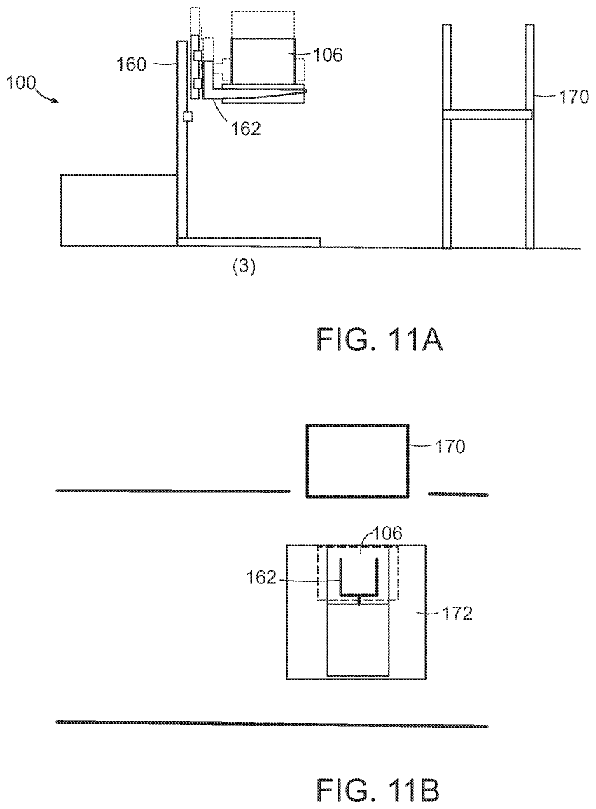

In the example embodiment of FIG. 11A AMR 100 may align forks and payload more precisely with infrastructure (shelf 170) before placing the payload on the shelf. Height adjustment is depicted in FIG. 11A with broken lines. As illustrated in the example embodiment of FIG. 11B safety region 172 may be expanded (in this illustration, laterally) in response to the forks being repositioned off center. Although the safety field expansion in the illustration is depicted as being equilateral, the vehicle may adjust safety fields unequally, for example expanding the side to which the forks have been shifted more than the opposite side. In this example the direction of movement is forward and straight, the speed is slow, the lift height is raised above travel height, the reach is that extended, side-shift is not centered, and the payload is present.

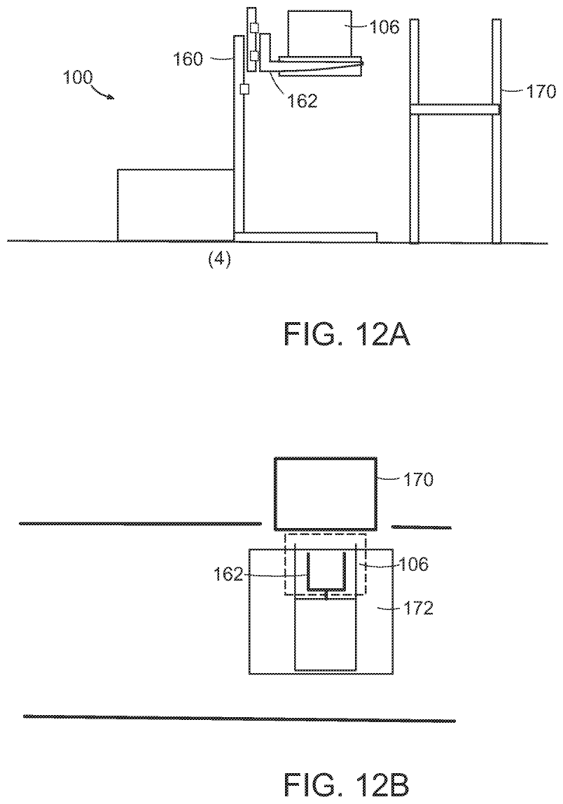

In the example embodiment of FIG. 12A AMR 100 begins to move toward shelf 170 in order to place the payload 106 on the shelf 170. To place the payload 106 on the shelf 170 the vehicle reduces its safety field in the direction in which it is approaching the shelf 170. Because the safety module 130 determines, whether through a training process or programming, that it is in the process of interacting with an object in its environment, carrying out a manipulation such as a pick or place operation, for example, the safety module 130 employs its proprioceptive information to adjust the safety field 172. Proprioceptive information may be obtained from, for example, the AMR's localization, speed, direction, carry height, centering, tilt, reach, payload presence, for example. Adjusting the safety field allows the AMR 100 to approach the shelf 170; without adjustment, it would stop as the shelf 170 approached. Reduction of the field that permits such an approach is illustrated in FIG. 12B where the field is withdrawn beyond the fork tips and payload in order to allow the AMR's approach.

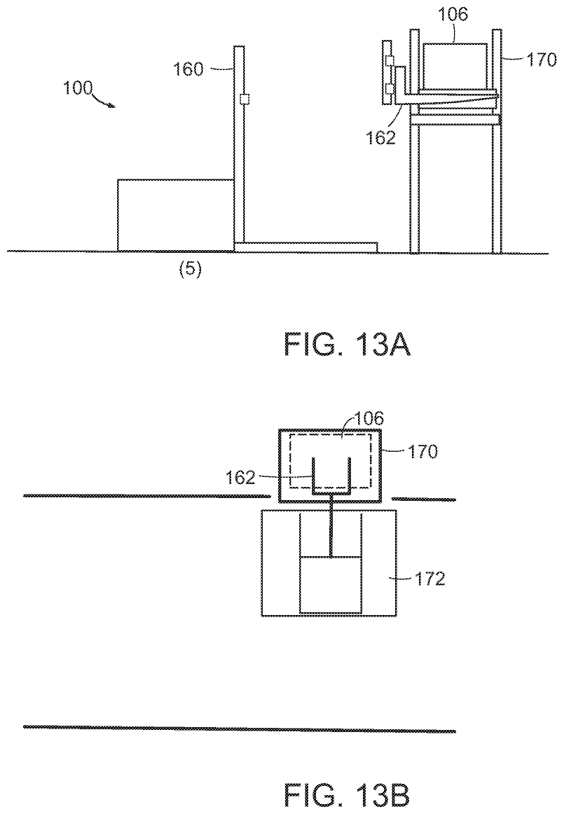

In FIG. 13A the pantograph has extended to place the payload 106 on the shelf 170. As illustrated in FIG. 13B, the safety field has been reduced in the direction of the shelf 170 to allow for placement of the payload 106. The forks 162 and payload 106 extend completely beyond the safety field 172 and over the shelf 170. In example embodiments AMR's safety module 130 takes into account proprioceptive information indicating that the AMR 100 is engaged in a manipulation (for example, pick or place) with the environment; the direction of travel is reversed/straight; the forks are lifted above travel height; reach is extended; side shift is centered; and a payload is present.

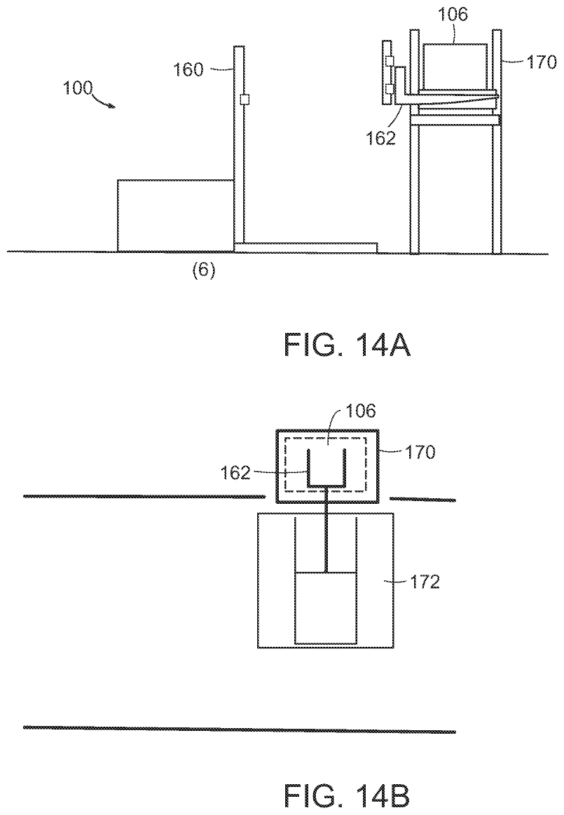

In FIG. 14A AMR 100 lowers its forks 162 to place the payload 106 on the shelf 170. Again, as illustrated in 14B, the safety field 172 is reduced to allow the AMR 100 to manipulate its environment (to place the payload 106). In this example, although the payload 106 has been lowered it is still above the travel height and the safety field is set by the AMR's safety module 130 according to proprioceptive information that includes: the vehicle is engaged in a load interaction; the direction is straight and reversed; the speed is slow; the lift is raised above a travel height; the reach is extended; side shift is centered; and a payload is present.

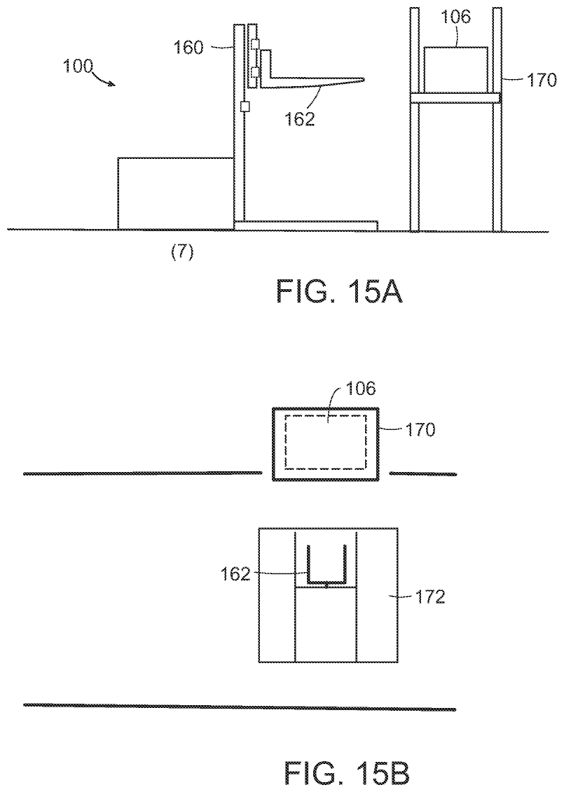

The pantograph is retracted in FIG. 15A after the vehicle has placed the payload on the table. The safety field remains truncated at the AMR's rear to allow the AMR to continue to operate in close proximity to the shelf 170. As illustrated in FIG. 15B proprioceptive information employed by the safety module 130 in this example may include: the AMR is operating straight line in reverse; the AMR speed is slow; the lift is raised above travel height; reach is retracted; side shift is centered; payload is absent; and a load manipulation is still underway.

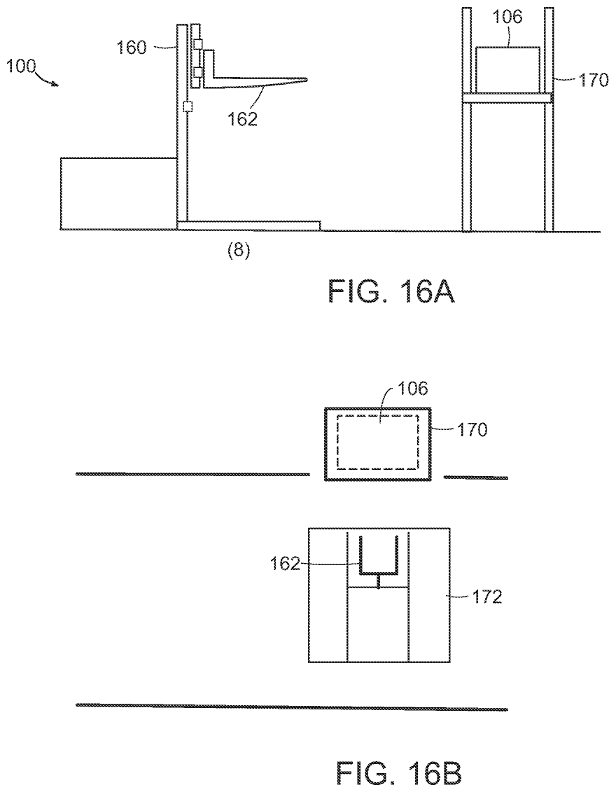

In FIG. 16A the AMR 100 has pulled away from the shelf 170 to complete the manipulation operation and the safety fields 172 have been returned to a nominal configuration in the rear, but, the sides remain extended because the lift height is above the travel level. In this example, the safety module 130 may be employing proprioceptive information including: forward straight travel; slow speed; lift raised above travel height; reach retracted; side shift centered; payload absent; and environmental manipulation complete.

Inventive concepts may be applied to any scenario in which an AMR manipulates an object within its environment. Such concepts may be used in an application where the AMR employs a forklift mechanism, in a warehousing environment for example, to pick or place a payload. Inventive concepts may be employed in agricultural or forestry applications, as well. For example, in agriculture, proprioceptive information may be employed in an agricultural or forestry application to determine whether an object is a weed (do be picked) or a crop item (to be watered or fertilized). Similarly, in forestry such information may be employed by an AMR in accordance with principles of inventive concepts to determine navigation and manipulation strategies for pruning and picking branches or fruits. Inventive concepts may be employed in AMRs used in retail settings, such as grocery store re-stockers and inventory counters. AMRs involved in maintenance and inspection may also employ inventive concepts in navigating and inspecting objects in the environment. Different forms of manipulators, including for example, forklift mechanisms, graspers, pincers, or others, may be employed in conjunction with an AMR in accordance with principles of inventive concepts. For brevity and clarity of explanation, though, inventive concepts have been described primarily in reference to an AMR operating within a warehouse environment and using a forklift mechanism to manipulate objects.

While the foregoing has described what are considered to be the best mode and/or other preferred embodiments, it is understood that various modifications may be made therein and that the invention or inventions may be implemented in various forms and embodiments, and that they may be applied in numerous applications, only some of which have been described herein. It is intended by the following claims to claim that which is literally described and all equivalents thereto, including all modifications and variations that fall within the scope of each claim.

1. An autonomous mobile robot, comprising:
a processor;
an exteroceptive sensing element to obtain exteroceptive information about the robot's environment;
a manipulation mechanism to manipulate an object within the robot's environment; and
a proprioceptive sensing element configured to obtain proprioceptive information about the robot, wherein the processor is configured to employ the exteroceptive information to guide the robot and proprioceptive information to manipulate an object within the robot's environment.

2. The autonomous mobile robot of claim 1, wherein the manipulation mechanism comprises a fork-lift mechanism.

3. The autonomous mobile robot of claim 1, wherein the processor is configured to establish a safety field to guide the robot.

4. The autonomous robot of claim 2, wherein the proprioceptive information includes information about the status of the fork-lift mechanism.

5. The autonomous robot of claim 1, wherein the proprioceptive information includes information about the status of a robot's manipulation operation.

6. An autonomous mobile robot, comprising:
at least one processor in communication with at least one computer memory device;
a safety field system having one or more sensors configured to generate a safety field;
at least one sensor configured to acquire sensor data based on a state of the robot; and
a safety field adjusting system configured to adjust a safety field based on the sensor data.

7. The robot of claim 6, wherein the safety field adjusting system is configured to adjust an area, depth, footprint, and/or direction of the safety field.

8. The robot of claim 6, wherein the safety field adjusting system is configured to adjust the safety field in a travel direction of the robot.

9. The robot of claim 6, wherein the safety field adjusting system is configured to adjust the safety field relative to a payload of the robot.

10. The robot of claim 6, wherein the state of the robot comprises and/or indicates at least one of: a lift, a tilt, a reach, and a side-shift of the robot or a portion of the robot.

11. The robot of claim 6, further comprising computer program code executable by the at least one processor to provide a signal configured to indicate load interaction.

12. The robot of claim 11, wherein the safety field adjusting system is configured to adjust the safety field based on the load interaction signal.

13. A method of dynamically adjusting and/or augmenting a safety field of an autonomous mobile robot, comprising:
establishing a safety field relative to the robot with one or more detectors;
at least one sensor acquiring sensor data based on a state of the robot; and
a safety field adjusting system adjusting a safety field based on the sensor data.

14. The method of claim 13, wherein adjusting the safety field includes adjusting an area, depth, footprint, and/or direction of the safety field.

15. The method of claim 13, wherein adjusting the safety field includes adjusting the safety field in a travel direction of the robot.

16. The method of claim 13, wherein adjusting the safety field includes adjusting the safety field relative to a payload of the robot.

17. The method of claim 13, wherein the state of the robot comprises and/or indicates at least one of a lift, a tilt, a reach, and a side-shift of the robot or a portion of the robot.

18. The method of claim 13, wherein the method includes the at least one sensor acquiring payload engagement data based on a state of payload engagement.

19. The method of claim 18, wherein the method includes the safety field adjusting system adjusting the safety field based on the payload engagement sensor data.

20. The method of claim 13, wherein the method further comprising computer program code executable by the at least one processor providing a signal configured to indicate load interaction and the safety field adjusting system adjusts the safety field based on the load interaction signal.
